(19) United States
(12) Patent Application Publication
(10) Pub. No.: US 2024/0219571 A1
(43) Pub. Date: Jul. 4, 2024

(54) EMITTING MODULE, DEPTH CAMERA AND HEAD MOUNT DISPLAY DEVICE

(71) Applicant: Beijing Zitiao Network Technology Co., Ltd., Beijing (CN)

(72) Inventor: Hualin Wang, Beijing (CN)

(21) Appl. No.: 18/533,137

(22) Filed: Dec. 7, 2023

(30) Foreign Application Priority Data
Dec. 30, 2022 (CN) 202211721055.2

(51) Int. Cl. G01S 17/89; G01S 7/481; G02B 26/08; G06T 7/521

(52) U.S. Cl. CPC G01S 17/89; G01S 7/4817; G02B 26/085; G06T 7/521; G02B 27/0172

(57) ABSTRACT

An emitting module, a depth camera and a head mount display device are provided by the present application. The emitting module includes a light source, a scanning unit and a rectifying unit. The light source is configured to emit a light beam; the scanning unit includes a driving portion and a scanning portion, the driving portion is configured to control the scanning portion to produce vibration according to a preset rule, and the scanning portion is configured to reflect the light beam emitted by the light source; the rectifying unit is configured to rectify an emission angle of the light beam reflected by the scanning portion, so that a plurality of points included in a point cloud picture formed by projecting the light beam rectified by the rectifying unit on a preset plane is arranged at equal intervals in at least one direction.

### CROSS-REFERENCE TO RELATED APPLICATION

The present application claims priority of Chinese Patent Application No. 202211721055.2, filed on Dec. 30, 2022, and the entire content disclosed by the Chinese patent application is incorporated herein by reference as part of the present application.

### TECHNICAL FIELD

This application belongs to the technical field of three-dimensional (3D) display, and particularly relates to an emitting module, a depth camera and a head mount display device.

### BACKGROUND

A depth camera can obtain the depth information of a target, so as to realize 3D scanning, scene modeling and gesture interaction. With the development of technology, the depth camera is gradually receiving attention from various industries.

In the related art, the depth camera includes an emitting module and a receiving module. The emitting module can emit a light beam onto a target to be detected, and the receiving module can receive the light beam reflected by the target to be detected, so as to obtain depth information.

However, the accuracy of the depth information obtained by the depth camera in the related art is poor.

### SUMMARY

Embodiments of this application provide an emitting module, a depth camera and a head mount display device, so as to improve the accuracy of the depth information obtained by the depth camera.

In a first aspect, an embodiment of this application provides an emitting module, applied in a depth camera, which includes a light source, configured to emit a light beam; a scanning unit, including a driving portion and a scanning portion, the driving portion being configured to control the scanning portion to produce vibration according to a preset rule, and the scanning portion being configured to reflect the light beam emitted by the light source; a rectifying unit, configured to rectify an emission angle of the light beam reflected by the scanning portion, so that a plurality of points included in a point cloud picture formed by projecting the light beam rectified by the rectifying unit on a preset plane is arranged at equal intervals in at least one direction. The preset plane is a plane perpendicular to a projection optical axis of the light beam which is rectified.

In a second aspect, an embodiment of this application provides a depth camera, which includes a receiving module and any emitting module as mentioned above, the light beam rectified by the rectifying unit of the emitting module is configured to be projected onto a target to be detected, and the receiving module is configured to receive the light beam reflected by the target to be detected.

In a third aspect, an embodiment of this application provides head mount display device, which includes a housing and any depth camera as mentioned above, the depth camera is connected to the housing.

According to the emitting module, the depth camera and the head mount display device provided by the embodiments of this application, a light source, a scanning unit and a rectifying unit are provided, and the light source is configured to emit a light beam; the scanning unit includes a driving portion and a scanning portion, the driving portion is configured to control the scanning portion to produce vibration according to a preset rule, and the scanning portion is configured to reflect the light beam emitted by the light source; the rectifying unit is configured to rectify an emission angle of the light beam reflected by the scanning portion, so that a plurality of points included in a point cloud picture formed by projecting the light beam rectified by the rectifying unit on a preset plane are arranged at equal intervals in at least one direction, thus alleviating the pincushion distortion problem of the projected light field after the scanning portion, improving the uniformity of the point cloud of the projected light field, and further improving the accuracy of the obtained depth information.

### BRIEF DESCRIPTION OF DRAWINGS

In order to more clearly explain the embodiments of this application or the technical scheme in the prior art, the drawings needed to be used in the description of the embodiments or the prior art will be briefly introduced below. Obviously, the drawings in the following description are some embodiments of this application, and other drawings can be obtained according to these drawings without creative work for ordinary people in the field. In the drawings:

FIG. 1 is a schematic diagram of an emitting module provided by an embodiment of this application;

FIG. 2 is the working principle diagram of a MEMS scanning unit in FIG. 1;

FIG. 3 is a motion waveform diagram of the scanning portion in FIG. 1;

FIG. 4a is a scanning trace of a light beam after passing through a scanning portion provided by an embodiment of this application;

FIG. 4b is a scanning trace of a light beam after passing through a rectifying unit provided by an embodiment of this application;

FIG. 4c is a partial enlarged view at position B in FIG. 4b;

FIG. 5 is one schematic structural diagram of the rectifying unit in FIG. 1;

FIG. 6 is another schematic structural diagram of the rectifying unit in FIG. 1;

FIG. 7 is further another schematic structural diagram of the rectifying unit in FIG. 1;

FIG. 8a is one schematic structural diagram of the light source in FIG. 1;

FIG. 8b is another schematic structural diagram of the light source in FIG. 1;

FIG. 9a is a schematic diagram of a light beam emitted by the light source in FIG. 1;

FIG. 9b is a schematic diagram of a light beam after passing through a collimating unit in FIG. 1; and

FIG. 10 is a schematic diagram of an emitting module provided by another embodiment of this application.

### DESCRIPTION OF REFERENCE NUMERALS

100: light source; 110: first reflecting portion;
111: first material layer; 112: second material layer;
120: second reflecting portion; 130: resonant cavity;
140: substrate; 150: light exiting hole;
160: luminous junction; 170: tunnel junction;
200: MEMS scanning unit; 210: scanning portion;
220: driving portion; 300: rectifying unit;
310: lens; 311: first surface;
312: second surface; 313: first convex portion;
314: second convex portion; 400: turning unit;
410: first right-angle prism; 411: first right-angle surface of first right-angle prism;
412: second right-angle surface of first right-angle prism; 413: hypotenuse surface
of first right-angle prism;
420: second right-angle prism; 421: first right-angle surface of second right-angle
prism;
422: second right-angle surface of second right-angle prism; 423: hypotenuse
surface of second right-angle prism;
500: circuit board; 600: support piece;
700: collimating unit; 800: controller.

### DETAILED DESCRIPTION

Hereinafter, embodiments of the present application will be described in detail, examples of which are illustrated in the drawings. The embodiments described below by referring to the drawings are exemplary and are intended to explain the application, and should not be construed as limiting the application.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of messages or information exchanged between multiple devices in the embodiment of this disclosure are only used for illustrative purposes, and are not used to limit the scope of these messages or information.

The embodiments of this application can be applied to various application scenarios, such as Extended Reality (XR), Virtual Reality (VR), Augmented Reality (AR), Mixed Reality (MR), etc.

First of all, some nouns or terms appearing in the process of describing the embodiments of this application are explained as follows.

Extended Reality (XR) is a concept including Virtual Reality (VR), Augmented Reality (AR) and Mixed Reality (MR), and represents the technology of creating an environment that connects the virtual world with the real world, allowing users to interact in real-time with the environment.

Virtual Reality (VR) is a technology of creating and experiencing a virtual world, computes and generates a virtual environment, is a kind of multi-source information (the virtual reality mentioned herein includes at least visual perception, in addition, it can further include auditory perception, tactile perception, motion perception, and even taste perception, olfactory perception, etc.), realizes simulation of a fused and interactive 3D dynamic scenes and physical behaviors in the virtual environment, immerses users in the simulated virtual reality environment, and realizes the application in various virtual environments such as maps, games, videos, education, medical care, simulation, collaborative training, sales, assistance in manufacturing, maintenance and repair, etc. Augmented Reality (AR) is a technology, which, during the process of capturing images by a camera, calculates the camera attitude parameters of the camera in the reality world (or the 3D world or the real world) in real time and adds virtual elements to the images captured by the camera according to the camera attitude parameters. The virtual elements include, but are not limited to: images, videos and 3D models. The goal of AR technology is to connect the virtual world with the real world for interaction on the screen.

Mixed Reality (MR) is a simulated scene that integrates the sensory input created by the computer (e.g., a virtual object) with the sensory input from the physical scene or its representation. In some MR scenes, the sensory input created by the computer can adapt to the changes of the sensory input from the physical scene. In addition, some electronic systems for presenting MR scenes can monitor the orientation and/or position with respect to the physical scenes, so that virtual objects can interact with real objects (i.e., physical elements from the physical scenes or their representations). For example, the system can monitor the motion so that the virtual plant appears stationary relative to the physical building.

Augmented Virtuality (AV) scene refers to a scene created by a computer or a simulated scene formed by incorporating at least one sensory input from a physical scene into a virtual scene. One or more sensory inputs from the physical scene can be a representation of at least one feature of the physical scene. For example, a virtual object can present the color of a physical element captured by one or more imaging sensors. For another example, a virtual object can exhibit features consistent with actual weather conditions in a physical scene, as identified via weather-related imaging sensors and/or online weather data. In another example, an augmented reality forest can have virtual trees and structures, but animals therein can have features accurately reproduced from images taken of physical animals.

Virtual view field refers to a region in the virtual environment that the user can perceive through the lens in the virtual reality device, and the perceived region is represented by Field Of View (FOV) of the virtual view field.

Virtual reality devices are terminals that realize virtual reality effects, can usually be provided in the form of glasses, Head Mount Display (HMD) and contact lenses to realize visual perception and other forms of perception. Of course, the implementation forms of the virtual reality devices are not limited thereto, and can be further miniaturized or enlarged as needed.

6DOF tracking: six degrees of freedom tracking. An object can have six degrees of freedom (6DOF) to move in 3D space. The six degrees of freedom are (1) forward/backward, (2) upward/downward, (3) leftward/rightward, (4) yaw, (5) pitch and (6) roll. Using a VR system that allows 6DOF, motions are free in a limited space, which allows users to make full use of all six degrees of freedom: yaw, pitch, roll, forward/backward, upward/downward and leftward/rightward. This makes the field of vision more realistic and real.

Micro-Electro-Mechanical System (MEMS), also known as Micro-electromechanical system, microsystems, micromechanics, etc., refers to high-tech devices with dimensions of several millimeters or even smaller.

In the related art, the depth camera includes an emitting module and a receiving module. The emitting module can emit a light beam onto a target to be detected, and the receiving module can receive the light beam reflected by the target to be detected, so as to obtain depth information.

However, the accuracy of the depth information obtained by the depth camera in the related art is poor.

In order to solve at least one of the above problems, the embodiments of this application provide an emitting module, a depth camera and a head mount display device, a light source, a MEMS scanning unit and a rectifying unit are provided, and the light source is configured to emit a light beam; the MEMS scanning unit includes a driving portion and a scanning portion, the driving portion is configured to control the scanning portion to produce vibration according to a preset rule, and the scanning portion is configured to reflect the light beam emitted by the light source; the rectifying unit is configured to rectify an emission angle of the light beam reflected by the scanning portion, so that a plurality of points included in a point cloud picture formed by projecting the light beam rectified by the rectifying unit on a preset plane is arranged at equal intervals in at least one direction, thus alleviating the pincushion distortion problem of the projected light field after the scanning portion, improving the uniformity of the point cloud of the projected light field, and further improving the accuracy of the obtained depth information.

The technical solutions of this application and how the technical solutions of this application solve the above technical problems will be described in detail with reference to specific embodiments. The several specific embodiments in the following can be combined with each other, and the same or similar concepts or processes may not be repeated in some embodiments. The embodiments of this application will be described below with reference to the accompanying drawings.

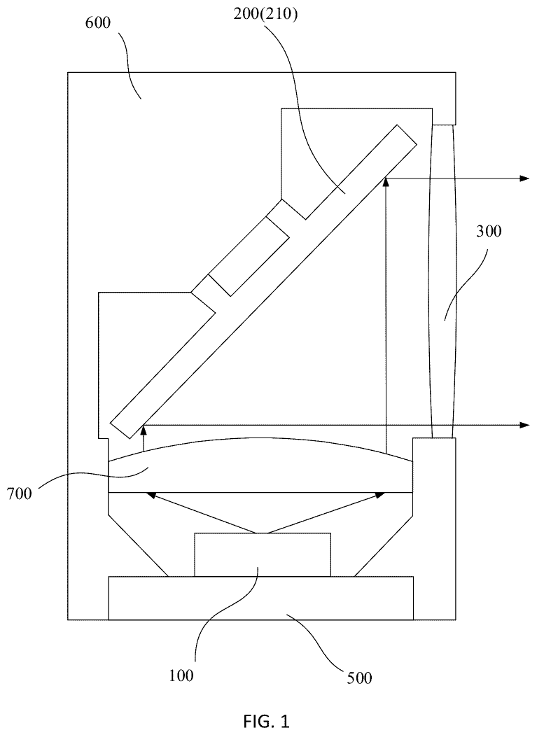

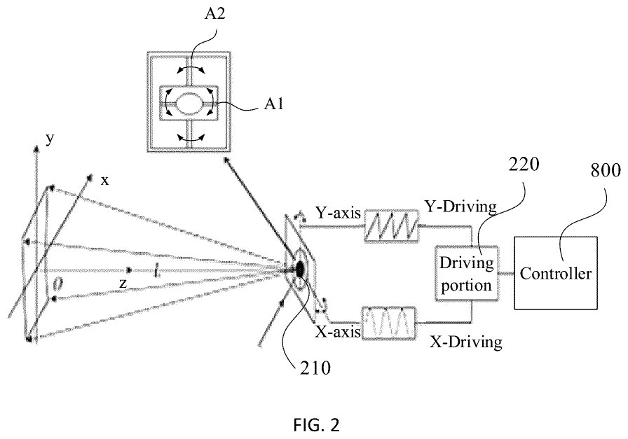

FIG. 1 is a schematic diagram of an emitting module provided by an embodiment of this application; FIG. 2 is the working principle diagram of the MEMS scanning unit in FIG. 1. Referring to FIG. 1 and FIG. 2, the embodiment of this application provides an emitting module, which is applied in a depth camera and includes: a light source 100, a MEMS scanning unit 200 and a rectifying unit 300. The light source 100 is configured to emit a light beam; the MEMS scanning unit 200 includes a driving portion 220 and a scanning portion 210, the driving portion 220 is configured to control the scanning portion 210 to produce vibration according to a preset rule, and the scanning portion 210 is configured to reflect the light beam emitted by the light source 100; the rectifying unit 300 is configured to rectify an emission angle of the light beam reflected by the scanning portion 210, so that a plurality of points included in a point cloud picture formed by projecting the light beam rectified by the rectifying unit 300 on a preset plane is arranged at equal intervals in at least one direction; the preset plane is a plane perpendicular to a projection optical axis of the rectified light beam.

The light source 100 can be configured to emit a light beam, and the light source 100 can be a laser emitter or the like.

The MEMS scanning unit 200 can be a MEMS micro-mirror, which refers to an optical MEMS device that integrates a micro light reflector with a MEMS driving device and is manufactured by optical MEMS technology. The MEMS scanning unit 200 includes a driving portion 220 and a scanning portion 210. The driving portion 220 can include a MEMS driving device, and the scanning portion 210 can include a micro light reflector. The scanning portion 210 can be configured to receive the light beam emitted by the light source 100 and reflect the light beam. The driving portion 220 can be connected to the scanning portion 210, so as to drive the scanning portion 210 to vibrate according to a preset rule, that is, cause the scanning portion 210 to be twisted, thereby realizing the directional deflection and graphical scanning of the light beam.

In addition, as shown in FIG. 2, the driving portion 220 can be connected to a controller 800, and the controller can be a control chip of a depth camera. In the case where the depth camera is applied in a head mount display device, the controller 800 can also be a control chip of the head mount display device. The controller 800 can be configured to generate a driving signal, such as a voltage signal or a current signal. After receiving the driving signal, the driving portion 220 can drive the scanning portion 210 to vibrate.

According to the classification of the driving modes of the MEMS scanning unit 200, the driving schemes can be divided into electrothermal driving, electrostatic driving, electromagnetic driving and piezoelectric driving, etc. In some embodiments, the electromagnetic driving scheme can be adopted in the present embodiment, so that a relatively larger FOV scanning angle can be realized.

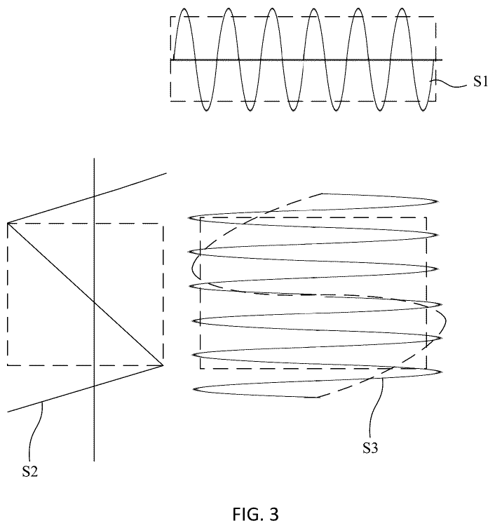

FIG. 3 is a motion waveform diagram of the MEMS scanning portion in FIG. 1. Referring to FIG. 2 and FIG. 3, in some embodiments, the vibration can include a first simple harmonic vibration in a first direction and a second simple harmonic vibration in a second direction, the first direction is perpendicular to the second direction, and the frequency ratio of the first simple harmonic vibration to the second simple harmonic vibration is an integer ratio.

Referring to FIG. 2 and FIG. 3, the first direction can be the X-axis direction, that is, the direction of the fast axis A1; and the second direction can be the Y-axis direction, that is, the direction of the slow axis A2.

It can be understood that the driving portion 220 can be configured to realize simultaneous vibration in two-dimensional directions, and the corresponding preset rule can be simple harmonic vibration law in the X-axis direction and the Y-axis direction, that is, the MEMS scanning unit 200 can be a two-dimensional MEMS vibrating mirror. Specifically, driven by the driving portion 220, the motion of the scanning portion 210 can be divided into a first simple harmonic vibration with the X axis as a torsion axis and a second simple harmonic vibration with the Y axis as a torsion axis. The waveform of the first simple harmonic vibration can be shown as the waveform S1 in FIG. 3, and the waveform of the second simple harmonic vibration can be shown as the waveform S2 in FIG. 3. In the case where the frequency ratio of the first simple harmonic vibration to the second simple harmonic vibration is an integer ratio, the scanning trace of a composite motion of the first simple harmonic vibration and the second simple harmonic vibration is stable and the scanning line is closed, which is shown as the waveform S3 in FIG. 3. In addition, in FIG. 3, the waveforms within the dashed box are scanning regions, and the waveforms at the outer side of the dashed box are non-scanning regions.

With continued reference to FIG. 2, it can be understood that the two-dimensional MEMS vibrating mirror can vibrate simultaneously in two-dimensional directions, and when one mass point simultaneously participates in two simple harmonic vibrations perpendicular to each other and with a frequency ratio of an integer, the scanning trace is stable and the scanning line is closed. Assuming that the two-dimensional MEMS vibrating mirror performs a first simple harmonic vibration and a second simple harmonic vibration respectively along the two directions of the X axis and the Y axis mutually perpendicular to each other, the equations of the pitch angle and azimuth angle of the light beam reflected by the scanning portion 210 can be expressed as follows:

$$θ = {A}_{1} cos ( 2 π {f}_{1} t + {φ}_{1} ) ; \\ φ = {A}_{2} cos ( 2 π {f}_{2} t + {φ}_{2} ) .$$

A₁ and A₂ represent the amplitudes of the first simple harmonic vibration and the second simple harmonic vibration, respectively; f₁ and f₂ represent the frequencies of the first simple harmonic vibration and the second simple harmonic vibration, respectively; and φ₁ and φ₂ represent the initial phases of the first simple harmonic vibration and the second simple harmonic vibration, respectively. For example, by adjusting the current of the control circuit of the driving portion 220 (changing A₁ and A₂), the initial phase difference in the X-axis and Y-axis directions (φ₁ and φ₂), and the modulation frequencies in the X-axis and Y-axis directions (changing f₁ and f₂), different scanning patterns can be realized, and the scanning light field pattern, imaging FOV adjustment and frame rate adjustment can be customized to meet different scanning requirements, thereby improving the customization of depth information acquisition of the head mount display device, and further improving the user experience of spatial positioning and perspective functions.

In some embodiments, the scanning angle of the MEMS scanning unit 200 in the X-axis direction can be in the range of 50-70 degrees, and the scanning angle of the MEMS scanning unit 200 in the Y-axis direction can be in the range of 35-55 degrees. For example, the scanning angle in the X-axis is 60 degrees, and the scanning angle in the Y-axis is 45 degrees. In addition, the scanning angle in the X-axis direction can be greater than the scanning angle in the Y-axis direction.

In some other embodiments, the vibration can include a first simple harmonic vibration in the first direction, and the first direction can be the X-axis or Y-axis direction, that is, the MEMS scanning unit 200 can also be a one-dimensional MEMS vibrating mirror, and the preset rule in this case can be the simple harmonic vibration law in the X-axis or Y-axis direction.

Both of the above two vibration modes can achieve scanning the target to be detected, so that the corresponding depth information can be obtained.

The rectifying unit 300 can be configured to receive the light beam reflected by the scanning portion 210, that is, the light beam emitted by the light source can pass through the scanning portion 210 and the rectifying unit 300 in turn; and the rectifying unit 300 can be configured to rectify the reflected light beam.

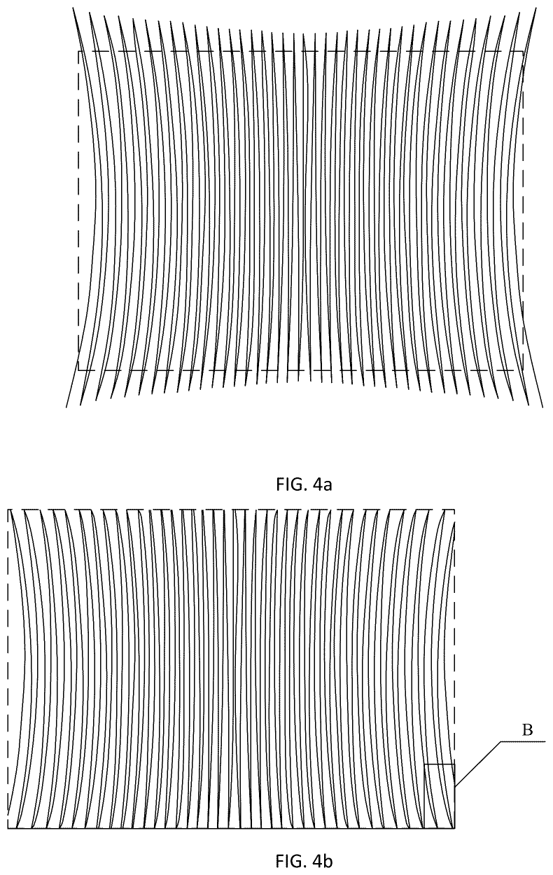

FIG. 4a is a scanning trace of a light beam after passing through a scanning portion provided by an embodiment of this application; FIG. 4b is a scanning trace of a light beam after passing through a rectifying unit provided by an embodiment of this application; and FIG. 4c is a partial enlarged view at position B in FIG. 4b. It can be understood that the scanning traces in FIG. 4a and FIG. 4b are both point cloud pictures composed of a plurality of points (enlarged as shown in FIG. 4c), and for the convenience of illustration, FIG. 4a and FIG. 4b only show solid line traces formed by connecting the plurality of points.

Referring to FIGS. 2 and 4a-4c, the rectifying unit can be set corresponding to the reflected light beam, and projection optical axes of the rectifying unit and the reflected light beam can be consistent. When the light beam is reflected by the scanning portion 210, its projection on a preset plane perpendicular to the projection optical axis of the light beam is as shown in FIG. 4a. It can be understood that the scanning trace in FIG. 4a is a point cloud picture composed of a plurality of points. Referring to FIG. 4a, the scanning trace has a pincushion distortion, that is, the picture appears to “shrink” towards the middle. If the scanning trace is used to directly scan the target to be detected, the pincushion distortion of the scanning trace will lead to inaccurate depth information obtained and poor accuracy.

Thus, in order to alleviate the pincushion distortion, a rectifying unit 300 is provided. The rectifying unit 300 can be configured to rectify the emission angle of the light beam reflected by the scanning portion 210, so that a plurality of points included in a point cloud picture formed by projecting the light beam rectified by the rectifying unit 300 on a preset plane is arranged at equal intervals in at least one direction.

It can be understood that FIG. 4b shows the point cloud picture of the scanning trace of the light beam after passing through the rectifying unit 300, and the dashed box therein can be of the same size as the dashed box in FIG. 4a. It can be understood that after passing through the rectifying unit 300, the scanning trace of the light beam becomes regular and rectangular, and as shown in FIG. 4c, the plurality of points in the point cloud picture is arranged at equal intervals in the Y axis, that is, the size of the interval between two adjacent points in the Y axis direction is equal, so as to realize the acquisition of two-dimensional depth point cloud data with equal intervals. Of course, in some other embodiments, they can also be arranged at equal intervals in the X axis, or arranged at equal intervals in the X axis and the Y axis at the same time. In some other embodiments, the scanning trace of the rectified light beam can also have other regular shapes, such as a round shape.

Referring to FIG. 4a and FIG. 4b, after being rectified by the rectifying unit 300, the plurality of points in the point cloud picture formed by the projection of the light beam on the preset plane is arranged at equal intervals in the Y axis, and the entire point cloud picture has a regular rectangular shape, so that the pincushion distortion can be rectified, and the depth information obtained by the depth camera is more accurate and has high accuracy.

In some embodiments, the rectifying unit 300 can include a lens 310, the lens 310 includes a first surface 311 and a second surface 312 which are oppositely arranged, and the light beam reflected by the scanning portion 210 enters the rectifying unit 300 from the first surface 311 and exits from the second surface 312.

It can be understood that the rectifying unit 300 can be a lens, which can be made of glass. The lens 310 can have two surfaces oppositely arranged, namely a first surface 311 and a second surface 312. The first surface 311 can be configured to receive the reflected light beam; after the light beam enters the lens 310, it can be rectified and exits from the second surface 312. The lens 310 is simple in structure, easy to be realized and small in volume. The number of lenses 310 can be one or more, such as two, and so on.

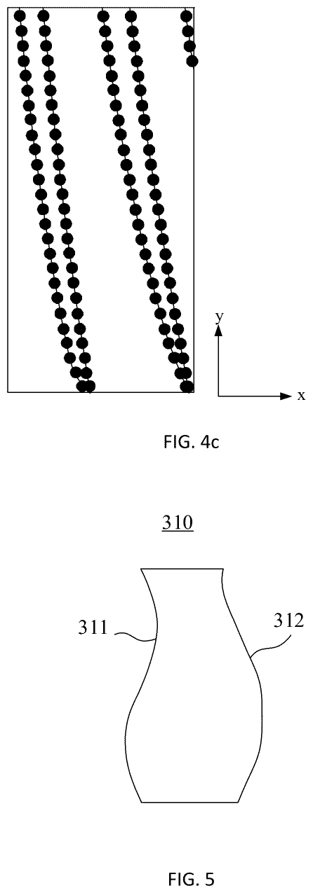

FIG. 5 is a schematic structural diagram of the rectifying unit in FIG. 1. Referring to FIG. 5, in some embodiments, the first surface 311 and the second surface 312 are free-form surfaces, respectively. The free-form surface refers to an optical surface without axis rotational symmetry or translational symmetry constraints. It can be understood that in the present embodiment, both the first surface 311 and the second surface 312 can be free-form surfaces, and their shapes can be the same or different.

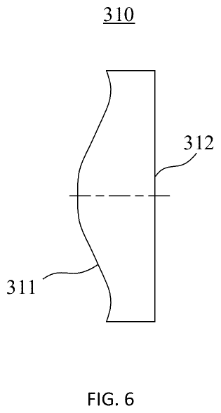

FIG. 6 is another schematic structural diagram of the rectifying unit in FIG. 1. Referring to FIG. 6, at least one of the first surface 311 or the second surface 312 is an aspheric surface. The aspheric surface refers to a surface whose curvature changes continuously from the center to the edge and is rotationally symmetric. It can be understood that only the first surface 311 is an aspheric surface in FIG. 5, for example, the first surface is a convex surface, and in some other embodiments, only the second surface 312 is an aspheric surface or both of them may be aspherical surfaces. In the case where both of them are aspherical surfaces, the first surface 311 and the second surface 312 can be the same or different.

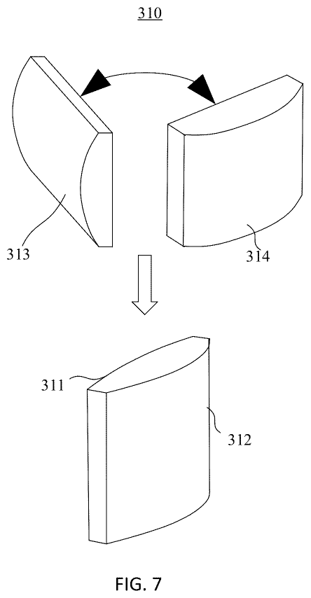

FIG. 7 is another schematic structural diagram of the rectifying unit in FIG. 1. Referring to FIG. 7, a first convex portion 313 and a second convex portion 314 are disposed at opposite sides of the lens 310, respectively, the surface of the first convex portion 313 away from the second convex portion 314 forms the first surface 311, and the surface of the second convex portion 314 away from the first convex portion 313 forms the second surface 312. The first convex portion 313 extends into a first column along a first extending direction, the second convex portion 314 extends into a second column along a second extending direction, and the first extending direction is perpendicular to the second extending direction.

It can be understood that the first convex portion 313 and the second convex portion 314 can be convex backwards, respectively, that is, the convex directions of the two convex portions are opposite to each other. As shown in FIG. 7, the lens 310 can include two cylindrical lenses, one provided with the first convex portion 313 and the other provided with the second convex portion 314. It can be understood that the cross-sectional shape of the cylindrical lens perpendicular to its extending direction is the same everywhere. The cylindrical lens provided with the first convex portion 313 (the cylindrical lens on the upper left in FIG. 7) can extend in the first extending direction, that is, the left-right direction in FIG. 7; and the cylindrical lens provided with the second convex portion 314 (the cylindrical lens on the upper right in FIG. 7) can extend in the second extending direction, that is, the up-down direction in FIG. 7. The lower lens 310 in FIG. 7 can be obtained by bonding the back surfaces of the two cylindrical lenses together. Of course, in another embodiment, the lens 310 can be integrally manufactured. For example, a size of the first convex portion in the first extension direction is equal to that of the second convex portion in the first extension direction, and a size of the first convex portion in the second extension direction is equal to that of the second convex portion in the second extension direction.

The above structures of the lens 310 can rectify the reflected light beam, thereby improving the accuracy of the depth information of the depth camera.

Of course, in some other embodiments, the rectifying unit 300 can also be made of structures, such as mirrors, which is not limited here.

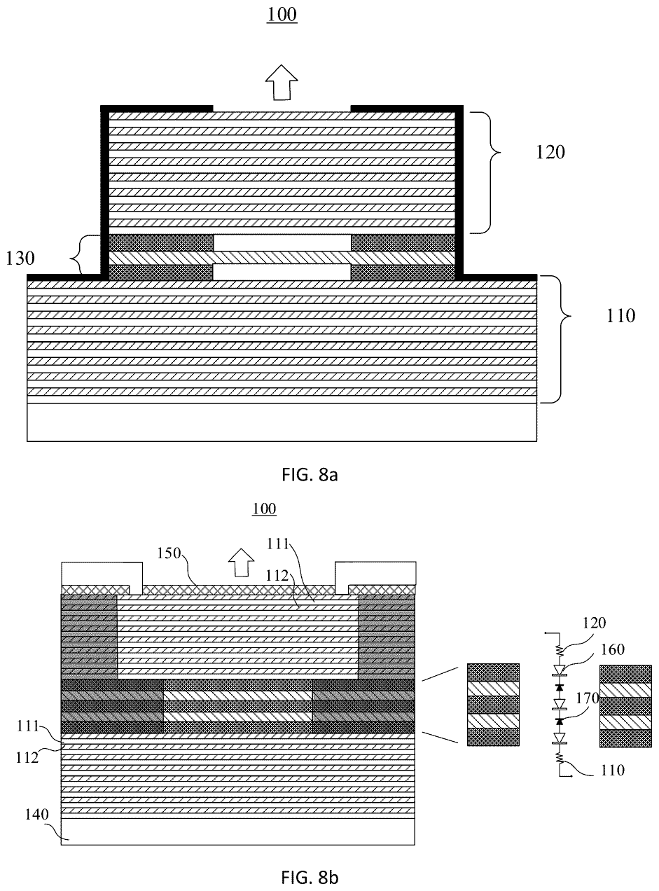

FIG. 8a is one schematic structural diagram of the light source in FIG. 1; and FIG. 8b is another schematic structural diagram of the light source in FIG. 1. Referring to FIG. 8a and FIG. 8b, in some embodiments, the light source 100 includes a Vertical-Cavity Surface-Emitting Laser (VCSEL). Compared with an Edge Emitting Laser (EEL), the VCSEL has a smaller divergence angle, and the VCSEL does not need a prism and other devices to turn the optical path, which is convenient for miniaturization and integration of modules.

In some embodiments, the vertical-cavity surface-emitting laser includes a first reflecting portion 110, a resonant cavity 130 and a second reflecting portion 120 which are sequentially arranged along a light exiting direction of the light source 100; the first reflecting portion 110 includes a plurality of first material layers 111 and a plurality of second material layers 112 which are alternately stacked along the light exiting direction of the light source 100; and the second reflecting portion 120 includes a plurality of first material layers 111 and a plurality of second material layers 112 which are alternately stacked along the light exiting direction of the light source 100.

The light exiting direction of the light source 100 can be the direction from bottom to top in FIG. 8a, the first reflecting portion 110 can be a bottom Bragg reflector N-DBR, and the second reflecting portion 120 can be a top Bragg reflector P-DBR. The first material layer 111 and the second material layer 112 can be an AlAs layer and a GaAs layer, respectively. In addition, the number of the first material layers 111 in the first reflecting portion 110 can be equal to the number of the first material layers 111 in the second reflecting portion 120. The resonant cavity 130 can include an InGaAs QW layer and an AlAs layer having oxide aperture. The thickness of the resonant cavity 130 is generally about several microns. Compared with the gain length of the EEL, the gain length of the active layer of the VCSEL is extremely small (tens of nanometers). In order to realize lasing, the DBR is set to have a high reflectivity (generally greater than 99%).

Referring to FIG. 8b, the resonant cavity 130 can include a structure consisting of luminous junctions 160 and tunnel junctions 170 alternately. In addition, the substrate 140 made of GaAs is generally at the bottom of the device of the VCSEL. The light exiting hole 150 can be disposed between two electrodes.

In some embodiments, the number of the first material layers 111 in the first reflecting portion 110 is in the range of 20-40, the number of the first material layers 111 in the second reflecting portion 120 can also be in the range of 20-40, and both number of them can be equal, so that a multi-section VCSEL can be realized. By increasing the number of DBR layers stacked in the VCSEL, the problem of low single-emitter power of the VCSEL can be improved, the peak emission power can be increased, the size of the VCSEL can be further reduced, and the cost can be saved.

It can be understood that the EEL is usually used as the light source in the related art, and the EEL has the advantage of high peak power. The head mount display device according to the present embodiment can be mainly used in indoor scenes within 5 m, without strong requirements for long-distance ranging; therefore, the peak power of the VCSEL can meet the index requirements. Secondly, the use of EEL makes it difficult to package the module, it is necessary to connect the EEL to the edge of the substrate and to dig a hole at the side of the light exiting hole of the EEL to place a prism turning light path, and the light beam emitted by the EEL has a fast axis and a slow axis, so it is necessary to place a cylindrical lens shaping light path at the position of the light exiting hole. In the present embodiment, the VCSEL is adopted, and there is no need to place a prism light path, and there is no fast axis and slow axis, which can simplify the light path design and module packaging process.

In some embodiments, the center wavelength of the VCSEL can be designed to be 850 nm or 940 nm, the power density of the VCSEL can reach 3 kW/mm², and the single-emitter peak emission power can reach more than 3 W, which can meet the requirement of ranging within 5 m of the depth camera for the head mount display device. The diameter of the light exiting hole 150 of the VCSEL can be greater than 12 um, thus ensuring that the emission power can meet the power requirements.

In some embodiments, the emitting module further includes a collimating unit 700, and the collimating unit 700 can be configured to collimate the light beam emitted by the light source 100.

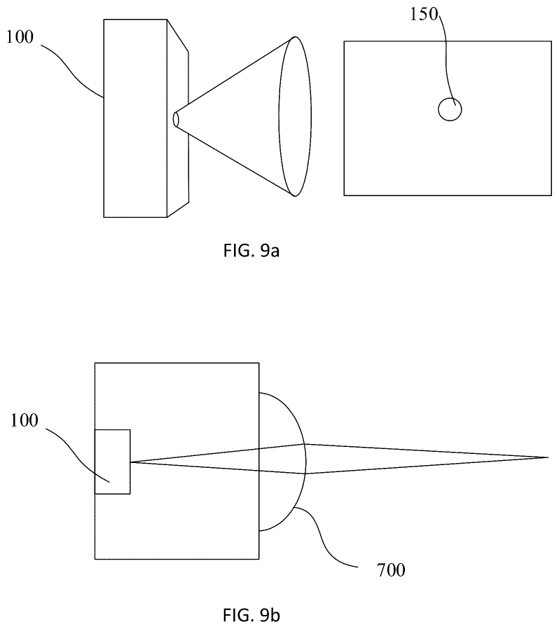

FIG. 9a is a schematic diagram of a light beam emitted by the light source in FIG. 1; and FIG. 9b is a schematic diagram of a light beam in FIG. 1 after passing through the collimating unit. Referring to FIG. 9a and FIG. 9b, it can be understood that the light beam emitted by the VCSEL has an emission angle, that is, the light beam is a conical light beam. The light beam with an emission angle is shown on the left side of FIG. 9a, and the shape of the light exiting hole 150 of the light source is shown on the right side of FIG. 9a. FIG. 9b shows that the collimating unit 700 can collimate the light beam with the emission angle to make it a parallel light beam.

The collimating unit 700 can be a lens made of glass, which can collimate the light beam emitted by the VCSEL into a parallel light beam and then irradiate it onto the MEMS scanning unit 200; and the size of the scanning portion 210 can be slightly larger than the size of the collimated light spot, so as to realize the complete reflection of the light beam energy.

In some embodiments, referring to FIG. 1, the light source 100, the collimating unit 700 and the scanning portion 210 are sequentially arranged at intervals along a light exiting direction of the light source 100, and a reflecting surface of the scanning portion 210 has a preset included angle with the light exiting direction. The rectifying unit 300 is located at one end of the scanning portion 210 along a preset direction, and the preset direction is perpendicular to the light exiting direction.

The preset included angle can be in the range of 0-90 degrees, so that the scanning portion 210 can be arranged obliquely. The preset direction can be the left-right direction in FIG. 1, and the light exiting direction of the light source 100 can be the direction from bottom to top in FIG. 1.

The light beam emitted by the light source 100 can be collimated by the collimating unit 700, then irradiated onto the scanning portion 210, and reflected by the scanning portion 210, then directed to the rectifying unit 300, and then exits the emitting module after being rectified, so that it can be irradiated onto the target to be detected, thus realizing the emission function of the depth camera.

In some embodiments, the emitting module can further include a circuit board 500 and a supporting piece 600, the light source 100 is installed on the circuit board 500; the supporting piece 600 and the circuit board 500 enclose an accommodating cavity for accommodating the collimating unit 700, the light source 100 and the scanning portion 210; the supporting piece 600 is provided with an installation hole, and the rectifying unit 300 is installed at the installation hole, thus realizing the package of the emitting module.

The light source 100 can be fixed on the circuit board 500 through Die Bond process or Wire Bond technology, the collimating unit 700 is installed above the light source 100 through the supporting piece 600, the scanning portion 210 is installed on the supporting piece 600, and the scanning angle and scanning frequency of the scanning portion 210 can be controlled through the driving circuit of the driving portion 220.

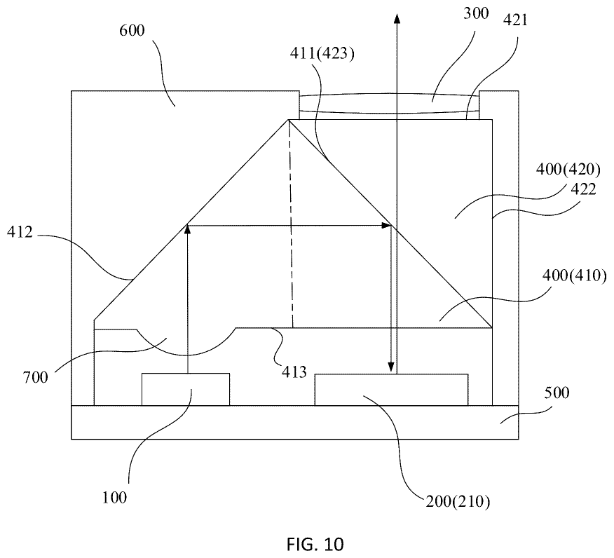

FIG. 10 is a schematic diagram of an emitting module provided by another embodiment of this application. Referring to FIG. 10, in some embodiments, the emitting module further includes a turning unit 400; the scanning portion 210 is located at one end of the light source 100 along a preset direction, and the preset direction is perpendicular to the light exiting direction of the light source 100; the collimating unit 700 is disposed at one end of the light source 100 along the light exiting direction, and the rectifying unit 300 is located at one end of the scanning portion 210 along the light exiting direction; the turning unit 400 is located between the collimating unit 700 and the rectifying unit 300, and is configured to change the propagation direction of the light beam collimated by the collimating unit 700, so that the collimated light beam is incident on the scanning portion, and the light beam reflected by the scanning portion 210 is directed to the rectifying unit.

The preset direction can be the left-right direction in FIG. 10, and the light exiting direction of the light source 100 can be the direction from bottom to top in FIG. 10.

The light beam emitted by the light source 100 can be collimated by the collimating unit 700, then irradiated onto the turning unit 400, then directed to the scanning portion 210, and can pass through the turning unit 400 after being reflected by the scanning portion 210, then be directed to the rectifying unit 300, and then exits the emitting module after being rectified, so that it can be irradiated onto the target to be detected, thus realizing the emission function of the depth camera.

In some embodiments, the turning unit 400 includes a first right-angle prism 410 and a second right-angle prism 420; the hypotenuse surface 413 of the first right-angle prism faces toward the light source 100 and the scanning portion 210, the collimating unit 700 is disposed at the position where the first right-angle prism 410 faces toward the light source 100, the first right-angle surface 411 of the first right-angle prism is attached to the hypotenuse surface 423 of the second right-angle prism, and the second right-angle prism 420 is located between the scanning portion 210 and the rectifying unit 300; a reflective layer is disposed on the second right-angle surface 412 of the first right-angle prism, and a transflective layer is disposed between the first right-angle surface 411 of the first right-angle prism and the hypotenuse surface 423 of the second right-angle prism.

It can be understood that a right-angle prism can include two right-angle surfaces and a hypotenuse face, and the two right-angle surfaces are perpendicular to each other.

The hypotenuse surface 413 of the first right-angle prism 410 can be perpendicular to the light exiting direction, which can cover the light source 100 and the scanning portion 210; and the collimating unit 700 can be disposed at the position of the hypotenuse surface 413 facing toward the light source 100, and a reflective layer with a reflecting function can be disposed on the second right-angle surface 412 of the first right-angle prism. The first right-angle surface 411 of the first right-angle prism can be attached to the hypotenuse surface 423 of the second right-angle prism, and the areas of them can be equal; and a transflective layer can be disposed between them. The transflective layer can both reflect a light beam and transmit a light beam. The first right-angle surface 421 of the second right-angle prism 420 can be perpendicular to the light exiting direction, which can be located between the rectifying unit 300 and the scanning portion 210.

The light beam emitted by the light source 100 can be collimated by the collimating unit 700, then incident into the first right-angle prism 410 after passing through the hypotenuse surface 413 of the first right-angle prism 410, and reflected by the reflective layer on the second right-angle surface 412, and then irradiated onto the transflective layer; a part of the light beam can be reflected and irradiated onto the scanning portion 210; the light beam reflected by the scanning portion 210 can be incident into the second right-angle prism 420 through the transflective layer, then directed to the rectifying unit 300 through the first right-angle surface 421, and then exits the emitting module after being rectified, thus realizing the emission function.

The collimating unit 700 and the first right-angle prism 410 can be integrally formed, or connected by a bonding process or the like. In addition, the first right-angle prism 410 may be a whole or composed of several right-angle prisms; for example, it can be divided into two parts along the center line in FIG. 10, and formed by bonding two right-angle prisms.

In some embodiments, as shown in FIG. 10, the emitting module can further include a circuit board 500 and a supporting piece 600, the light source 100 is installed on the circuit board 500; the supporting piece 600 and the circuit board 500 enclose an accommodating cavity for accommodating the collimating unit 700, the light source 100 and the scanning portion 210; the supporting piece 600 is provided with an installation hole, and the rectifying unit 300 is installed at the installation hole, thus realizing the package of the emitting module. The turning unit 400 can also be accommodated in the accommodating cavity to realize the package of the emitting module.

The second right-angle surface 412 of the first right-angle prism 410 and the second right-angle surface 422 of the second right-angle prism 420 can be connected to the supporting piece 600.

In the present embodiment, the turning of the light path can be realized through the turning unit 400, so that the light beam can be projected into the scene. In addition, the light source 100 and the scanning portion 210 can be set to share the circuit board 500, which can simplify the circuit wiring.

An embodiment of this application further provides a depth camera, which includes a receiving module and an emitting module; the light beam rectified by the rectifying unit 300 of the emitting module is configured to be projected onto a target to be detected, and the receiving module is configured to receive the light beam reflected by the target to be detected.

The structure and function of the emitting module are the same as those of the above-mentioned embodiments, and details will not be repeated. The target to be detected can be people or things, etc., in the scene.

The receiving module can be designed as one complementary metal oxide semiconductor (CMOS) camera (constructed into a monocular structured light scheme), two CMOS cameras (constructed into an active binocular scheme), one indirect time of flight (ITOF) detecting camera (constructed into an ITOF scheme), one direct time of flight (DTOF) detecting camera (constructed into a DTOF scheme), etc.

After receiving the light beam reflected by the target to be detected, the receiving module can obtain the depth information of the target to be detected after processing.

The depth camera provided by the embodiment of this application can improve the pincushion distortion problem of the projected light field after the scanning portion, improve the uniformity of the point cloud of the projected light field, and further improve the accuracy of the obtained depth information.

An embodiment of the application further provides a head mount display device, which can be applied in various application scenarios, such as Extended Reality (XR), Virtual Reality (VR), Augmented Reality (AR), Mixed Reality (MR), etc.

The head mount display device includes a housing and a depth camera, and the depth camera is connected to the housing. The structure and function of the depth camera are the same as those of the above-mentioned embodiment, and details will not be repeated.

The head mount display device provided by the embodiment of this application, by setting the depth camera, can improve the accuracy of depth information, be used to accurately detect the surrounding environment, and be helpful for improving the user experience.

Taking that the head mount display device is a VR device as an example, the VR device can realize the depth information acquisition function of the VR device through the depth camera. In addition, the VR device can be equipped with a depth camera and a 6DOF tracking camera at the same time. By fusing the grayscale image information of the 6DOF tracking camera with the depth information of the depth camera, the positioning accuracy of the VR device in dark scenes and textureless scenes, as well as the robustness and stability of the 6DOF algorithm, can be improved. In addition, the VR device can also be equipped with a depth camera and a see through camera at the same time. By fusing the RGB color image information of the see through camera with the depth information of the depth camera, the fixation point rendering function of the VR headset shooting external scenes can be realized, the human eye perception effect can be better simulated, and the user experience can be improved.

In the description of this specification, descriptions referring to the terms “one embodiment”, “some embodiments”, “examples”, “specific examples” or “some examples” mean that specific features, structures, materials or characteristics described in connection with this embodiment or example are included in at least one embodiment or example of this application. In this specification, the schematic expressions of the above terms do not necessarily refer to the same embodiment or example. Moreover, the specific features, structures, materials or characteristics described may be combined in any one or more embodiments or examples in a suitable manner.

In the description of this application, it should be understood that, the azimuth or positional relationship indicated by the terms “center”, “vertical”, “horizontal”, “length”, “width”, “thickness”, “on”, “below”, “front”, “back”, “left”, “right”, “vertical”, “horizontal”, “top”, “bottom”, “inside”, “outside”, “clockwise”, “counterclockwise”, “axial”, “radial” and “circumferential” are based on the azimuth or positional relationship shown in the attached drawings only. It is only for the convenience of describing the application and simplifying the description, and does not indicate or imply that the referred devices or elements must have a specific orientation, be constructed and operated in a specific orientation, so it cannot be understood as a limitation of the application.

In addition, the terms “first” and “second” used in the embodiment of this application are only used for descriptive purposes, and cannot be understood as indicating or implying relative importance or implicitly indicating the number of technical features indicated in this embodiment. Therefore, the features defined by terms such as “first” and “second” in the embodiment of the application can explicitly or implicitly indicate that the embodiment includes at least one such feature. In the description of this application, the word “multiple” means at least two or two or more, such as two, three, four, etc., unless otherwise specifically defined in the examples.

In this application, the terms “installed”, “connected”, “connection” and “fixed” appearing in the embodiment should be broadly understood unless otherwise specified or limited in the embodiment. For example, the connection can be fixed, detachable or integrated, which can be understood, and can also be mechanical connection or electrical connection. Of course, it can also be directly connected, or indirectly connected through an intermediary, or it can be the internal communication of two elements, or the interaction between two elements. For those skilled in the art, the specific meanings of the above terms in this application can be understood according to the specific implementation.

In this application, unless otherwise specified and limited, the first feature “on” or “below” the second feature may be that the first and second features are in direct contact, or the first and second features are in indirect contact through an intermediary. Moreover, the first feature is “on”, “over” and “above” the second feature, which can mean that the first feature is directly above or obliquely above the second feature, or just means that the horizontal height of the first feature is higher than the second feature. The first feature is “under”, “below” and “beneath” the second feature can mean that the first feature is directly or obliquely below the second feature, or just means that the horizontal height of the first feature is smaller than the second feature.

The above is only the specific implementation of this application, but the protection scope of this application is not limited to this. Any person with this technical field can easily think of changes or substitutions within the technical scope disclosed in this application, which should be included in the protection scope of this application. Therefore, the protection scope of this application should be based on the protection scope of this claim.

1. An emitting module, applied in a depth camera, comprising:
a light source, configured to emit a light beam;
a scanning unit, comprising a driving portion and a scanning portion, wherein the driving portion is configured to control the scanning portion to produce vibration according to a preset rule, and the scanning portion is configured to reflect the light beam emitted by the light source;
a rectifying unit, configured to rectify an emission angle of the light beam reflected by the scanning portion, so that a plurality of points included in a point cloud picture formed by projecting the light beam rectified by the rectifying unit on a preset plane is arranged at equal intervals in at least one direction; wherein the preset plane is a plane perpendicular to a projection optical axis of the light beam which is rectified.

2. The emitting module according to claim 1, wherein the rectifying unit comprises a lens, the lens comprises a first surface and a second surface which are oppositely arranged, and the light beam reflected by the scanning portion enters the rectifying unit from the first surface and exits from the second surface.

3. The emitting module according to claim 2, wherein the first surface and the second surface are free-form surfaces, respectively.

4. The emitting module according to claim 2, wherein at least one of the first surface or the second surface is an aspheric surface.

5. The emitting module according to claim 2, wherein the lens comprises a first convex portion and a second convex portion disposed at opposite sides, respectively;
a surface of the first convex portion away from the second convex portion forms the first surface, and a surface of the second convex portion away from the first convex portion forms the second surface;
the first convex portion extends into a first column along a first extending direction, the second convex portion extends into a second column along a second extending direction, and the first extending direction is perpendicular to the second extending direction.

6. The emitting module according to claim 1, wherein
the vibration comprises a first simple harmonic vibration in a first direction; or
the vibration comprises a first simple harmonic vibration in a first direction and a second simple harmonic vibration in a second direction, the first direction is perpendicular to the second direction, and a frequency ratio of the first simple harmonic vibration to the second simple harmonic vibration is an integer ratio.

7. The emitting module according to claim 1, wherein
the light source comprises a vertical-cavity surface-emitting laser.

8. The emitting module according to claim 7, wherein the vertical-cavity surface-emitting laser comprises: a first reflecting portion, a resonant cavity and a second reflecting portion which are sequentially arranged along a light exiting direction of the light source;
the first reflecting portion and the second reflecting portion both comprise a plurality of first material layers and a plurality of second material layers which are alternately stacked along the light exiting direction of the light source.

9. The emitting module according to claim 8, wherein a count of the first material layers in the first reflecting portion is in a range of 20-40, a count of the first material layers in the second reflecting portion is in a range of 20-40, and a diameter of a light exiting hole of the vertical-cavity surface-emitting laser is greater than 12 um.

10. The emitting module according to claim 1, further comprising:
a collimating unit, configured to collimate the light beam emitted by the light source.

11. The emitting module according to claim 10, wherein the light source, the collimating unit and the scanning portion are sequentially arranged at intervals along a light exiting direction of the light source, and a reflecting surface of the scanning portion has a preset included angle with the light exiting direction;
the rectifying unit is located at one end of the scanning portion along a preset direction, and the preset direction is perpendicular to the light exiting direction.

12. The emitting module according to claim 10, further comprising: a turning unit;
the scanning portion is located at one end of the light source along a preset direction, and the preset direction is perpendicular to a light exiting direction of the light source;
the collimating unit is disposed at one end of the light source along the light exiting direction, and the rectifying unit is located at one end of the scanning portion along the light exiting direction;
the turning unit is located between the collimating unit and the rectifying unit, and is configured to change a propagation direction of the light beam collimated by the collimating unit, so that the light beam which is collimated is incident on the scanning portion, and the light beam reflected by the scanning portion is directed to the rectifying unit.

13. The emitting module according to claim 12, wherein the turning unit comprises a first right-angle prism and a second right-angle prism;
a hypotenuse surface of the first right-angle prism faces toward the light source and the scanning portion, the collimating unit is disposed at a position where the first right-angle prism faces toward the light source, a first right-angle surface of the first right-angle prism is attached to a hypotenuse surface of the second right-angle prism, and the second right-angle prism is located between the scanning portion and the rectifying unit;
a reflective layer is disposed on a second right-angle surface of the first right-angle prism, and a transflective layer is disposed between the first right-angle surface of the first right-angle prism and the hypotenuse surface of the second right-angle prism.

14. The emitting module according to claim 10, further comprising:
a circuit board, wherein the light source is installed on the circuit board;
a supporting piece, wherein the supporting piece and the circuit board enclose an accommodating cavity for accommodating the collimating unit, the light source and the scanning portion; the supporting piece is provided with an installation hole, and the rectifying unit is installed at the installation hole.

15. The emitting module according to claim 1, wherein the scanning unit comprises a MEMS scanning unit.

16. The emitting module according to claim 5, wherein the first convex portion and the second convex portion are attached to each other or an integrated structure.

17. The emitting module according to claim 5, wherein a size of the first convex portion in the first extension direction is equal to that of the second convex portion in the first extension direction, and a size of the first convex portion in the second extension direction is equal to that of the second convex portion in the second extension direction.

18. A depth camera, comprising a receiving module and the emitting module according to claim 1;
wherein the light beam rectified by the rectifying unit of the emitting module is configured to be projected onto a target to be detected, and the receiving module is configured to receive the light beam reflected by the target to be detected.

19. A head mount display device, comprising: a housing and the depth camera according to claim 18, wherein the depth camera is connected to the housing.
